(19) United States
(12) Patent Application Publication
(10) Pub. No.: US 2022/0394089 A1
(43) Pub. Date: Dec. 8, 2022

(54) INFORMATION PROCESSING APPARATUS, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Yuichi MOTOKI, Kanagawa (JP)

(73) Assignee: FUJIFILM Business Innovation Corp., Tokyo (JP)

(21) Appl. No.: 17/535,669

(22) Filed: Nov. 25, 2021

(30) Foreign Application Priority Data
Jun. 7, 2021 (JP) 2021-094992

(51) Int. Cl. H04L 67/1042; H04L 67/06; G06F 21/62; G06F 16/176

(52) U.S. Cl. CPC H04L 67/1044; H04L 67/06; G06F 21/6209; G06F 16/176

(57) ABSTRACT

An information processing apparatus includes: a processor configured to: perform control such that a first display region in which a file that is not distributed to a person in charge is displayed and a second display region in which a file that is distributed to each person in charge is displayed are displayed on an identical screen; perform control such that a status of each person in charge is displayed in the second display region; and distribute the file displayed in the first display region to the person in charge according to an operation of moving the file displayed in the first display region to the second display region.

### CROSS-REFERENCE TO RELATED APPLICATIONS

This application is based on and claims priority under 35 USC 119 from Japanese Patent Application No. 2021-094992 filed Jun. 7, 2021.

### BACKGROUND

### (i) Technical Field

The present invention relates to an information processing apparatus, a non-transitory computer readable medium storing a program, and an information processing method.

### (ii) Related Art

An administrator of a file may distribute the file to a person in charge who is requested to process the file. In a case of determining the person in charge, the person in charge of the file is determined in consideration of states of candidates of the person in charge.

Therefore, in order to grasp the states of the candidates of the person in charge, a screen showing the states of the candidates of the person in charge are separately displayed, the person in charge is determined after grasping the states of the candidates of the person in charge, and the file is distributed to the determined person in charge on a screen for distributing the file.

Examples of related art include JP2014-092806A, JP2018-159967A, and JP2012-058935A.

### SUMMARY

Meanwhile, the administrator of the file has to determine the person in charge of the file and distribute the file by using a plurality of screens, which is complicated.

Aspects of non-limiting embodiments of the present disclosure relate to an information processing apparatus, a non-transitory computer readable medium storing a program, and an information processing method that reduce, as compared with a case where a screen for displaying a state of a candidate of a person in charge of a file and a screen for distributing the file to the person in charge of the file are displayed on separate screens, the number of operations required for a file administrator to determine the person in charge of the file and to distribute the file.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including: a processor configured to: perform control such that a first display region in which a file that is not distributed to a person in charge is displayed and a second display region in which a file that is distributed to each person in charge is displayed are displayed on an identical screen; perform control such that a status of each person in charge is displayed in the second display region; and distribute the file displayed in the first display region to the person in charge according to an operation of moving the file displayed in the first display region to the second display region.

### BRIEF DESCRIPTION OF THE DRAWINGS

Exemplary embodiment(s) of the present invention will be described in detail based on the following figures, wherein:

FIG. 1 is a block configuration diagram of an entire system that processes tasks according to the present exemplary embodiment;

FIG. 2 is a table illustrating an example of a data configuration of user management information stored in a user management information storage unit according to the present exemplary embodiment;

FIG. 3 is a table illustrating an example of a data configuration of file management information stored in a file management information storage unit according to the present exemplary embodiment;

FIG. 4 is a table illustrating an example of a data configuration of person-in-charge management information stored in a person-in-charge status information storage unit according to the present exemplary embodiment;

FIG. 5 is a diagram illustrating a display example of a user management screen according to the present exemplary embodiment;

FIG. 6A is a flowchart illustrating a process until a file is processed according to the present exemplary embodiment;

FIG. 6B is a flowchart following FIG. 6A;

FIG. 7 is a diagram illustrating an example of a screen display of a workspace for administrator according to the present exemplary embodiment;

FIG. 8 is a diagram illustrating an operation of the administrator and information updated in response to the operation in the workspace illustrated in FIG. 7;

FIG. 9 is a diagram illustrating an example of contents of a request message according to the present exemplary embodiment;

FIG. 10 is a diagram illustrating an example of contents of a rejection message used in the present exemplary embodiment;

FIG. 11 is a diagram illustrating an example of contents of an acceptance message used in the present exemplary embodiment;

FIG. 12 is a diagram illustrating an example of a screen display of a workspace for person in charge in the present exemplary embodiment;

FIG. 13 is a diagram illustrating an operation of the person in charge and information updated in response to the operation in the workspace illustrated in FIG. 12;

FIG. 14 is a diagram illustrating the operation of a person in charge and an example of display contents in response to the operation in the workspace illustrated in FIG. 12; and

FIG. 15 is a diagram illustrating another example of the screen display of the workspace for administrator according to the present exemplary embodiment.

### DETAILED DESCRIPTION

Hereinafter, exemplary embodiments of the present disclosure will be described with reference to the drawings.

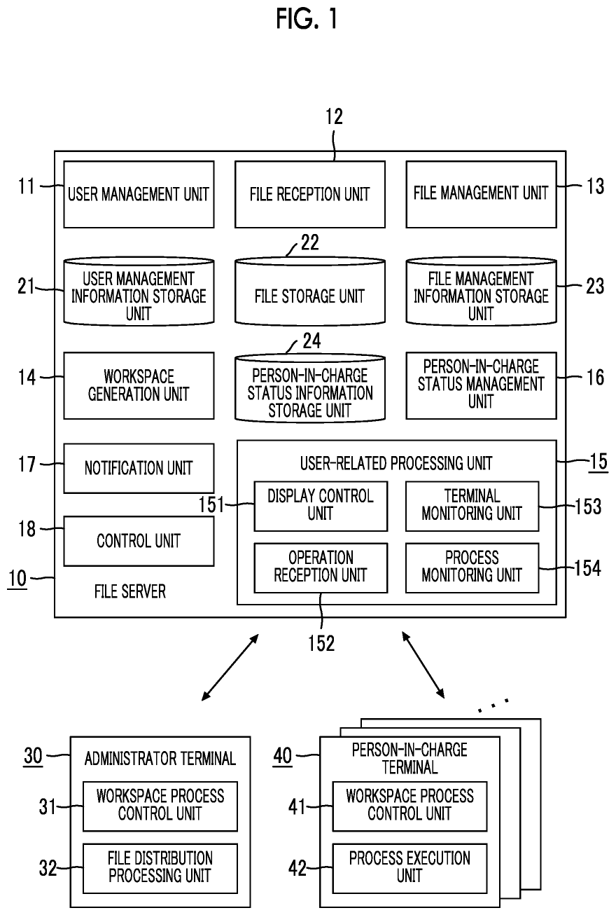

FIG. 1 is a block configuration diagram of an entire information processing system that processes tasks according to the present exemplary embodiment. FIG. 1 illustrates a file server 10, an administrator terminal 30, and a plurality of person-in-charge terminals 40. Each of the administrator terminal 30 and the person-in-charge terminals 40 can communicate with at least the file server via a network (not illustrated). The network is configured with a wired or wireless local area network (LAN) or the Internet, or a combination of the LAN and the Internet, depending on an installation position of each of the information processing apparatuses 10, 30, and 40. In order to process a task related to one business, the present exemplary embodiment will be described on the assumption that each of the information processing apparatuses 10, 30, and 40 is connected to the identical LAN. In a case where the network includes the Internet or the like with poor confidentiality, by using a virtual private network (VPN) or the like, network communication is performed while maintaining security.

The information processing system according to the present exemplary embodiment is a system that processes a file as a task, for example, in a case where a predetermined process is executed on a file corresponding to electronic data of an invoice (hereinafter, simply referred to as “invoice”). The above-described “person in charge” is a user who uses the person-in-charge terminal 40 to process an invoice distributed by an administrator, among invoices as files to be processed. In this manner, the person in charge has a job of processing the invoice.

Since the person in charge has a job of processing the invoice by using the person-in-charge terminal 40, and the person-in-charge terminal 40 processes the process of the invoice as a task in a case where the person in charge performs the job, in the present exemplary embodiment, the “job” performed by the person in charge and the “task” processed by the person-in-charge terminal 40 are used as synonymous terms.

Further, the “administrator” is a user who performs a process of distributing an invoice that is not yet distributed to the person in charge among invoices to be processed, to any person in charge. In this manner, the job of the administrator is to distribute the invoice to any person in charge and process the invoice.

Further, as is clear from the above description, the “file” in the present exemplary embodiment is a data file on a computer to be processed by the administrator and the person in charge.

The file server 10 according to the present exemplary embodiment can be realized by a hardware configuration of a general-purpose server computer that exists in the past. That is, the file server 10 as the information processing apparatus according to the exemplary embodiment of the present invention includes a CPU, a ROM, a RAM, a hard disk drive (HDD) as a storage section, and a network interface (IF) provided as a communication section. Further, as necessary, the file server 10 may have a user interface including an input section such as a mouse or keyboard and a display section such as a display.

As illustrated in FIG. 1, the file server 10 according to the present exemplary embodiment includes a user management unit 11, a file reception unit 12, a file management unit 13, a workspace generation unit 14, a user-related processing unit 15, a person-in-charge status management unit 16, a notification unit 17, a control unit 18, a user management information storage unit 21, a file storage unit 22, a file management information storage unit 23, and a person-in-charge status information storage unit 24. Components not used in the description of the present exemplary embodiment are omitted from FIG. 1.

The user management unit 11 manages information on a user who uses the present system, that is, an administrator and a person in charge. The user management unit 11 manages the user by registering, updating, deleting, or the like user management information stored in the user management information storage unit 21. In a case where a file to be processed by any person in charge is transmitted from an outside, the file reception unit 12 receives the file and stores the file in the file storage unit 22. File management information on the file stored in the file storage unit 22 is stored in the file management information storage unit 23, and the file management unit 13 registers, updates, deletes, or the like the file management information stored in the file management information storage unit 23.

The workspace generation unit 14 generates a workspace by referring to the file management information stored in the file management information storage unit 23 and the person-in-charge management information stored in the person-in-charge status information storage unit 24. The “workspace” is a work space formed on a computer for the administrator and the person in charge for a job. The workspace is generated in different display formats for the administrator and the person in charge, as will be described below.

The user-related processing unit 15 has a function of performing a user-related process by exchanging information between the administrator terminal 30 and the plurality of person-in-charge terminals 40 via the network. The user-related processing unit 15 includes a display control unit 151, an operation reception unit 152, a terminal monitoring unit 153, and a process monitoring unit 154. The display control unit 151 controls a display on each of the terminals 30 and 40, particularly a display of the workspace. The operation reception unit 152 receives user operations for each of the terminals 30 and 40, particularly user operations for the displayed workspace. The terminal monitoring unit 153 monitors whether each of the terminals 30 and 40 is operating, and in particular, whether or not a predetermined application is started and the workspace is displayed on a screen. The process monitoring unit 154 monitors an execution status of a process for a file on the person-in-charge terminal 40.

The notification unit 17 notifies the user of necessary information by transmitting a message to the terminals 30 and 40 as necessary. The control unit 18 controls an execution of a file distribution process, which will be described below, by coordinating the other components 11 to 17.

As described above, the file storage unit 22 stores a file accepted as a target to be processed. More specifically, for example, a file ID as information for identifying the file is associated with the received file, and the file is stored.

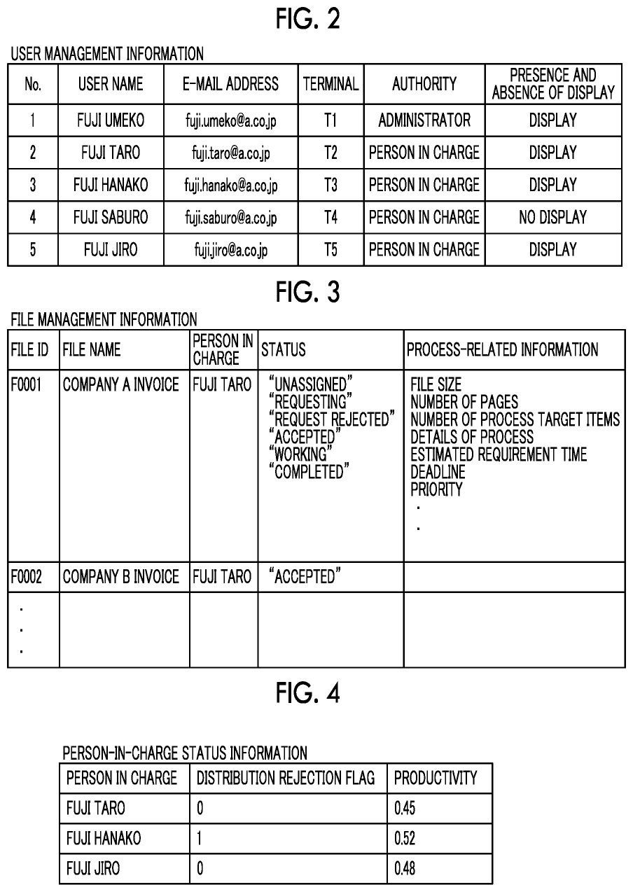

FIG. 2 is a table illustrating an example of a data configuration of user management information stored in the user management information storage unit 21 according to the present exemplary embodiment. The user management information is information to be used to manage users who use the present system. The user management information is No., a user name, an e-mail address, a terminal, authority, and presence and absence of display. No. is a serial number assigned to each user, and can be information for identifying each user. The user name is a name of a user who uses the present system, and is information for specifying the user. The e-mail address is information that specifies a transmission destination of a message or the like to the user. The terminal is information that specifies a terminal used by the user. In the present exemplary embodiment, since the message is transmitted to the user, for example, an IP address is set as information for specifying the destination. The authority is information indicating whether the user is an administrator or a person in charge. The presence and absence of display is information indicating whether or not the user is a display target in the workspace. In a case where the presence and absence of display is “display”, the user is displayed in the workspace, and in a case where the presence and absence of display is “no display”, the user is not displayed in the workspace.

FIG. 3 is a table illustrating an example of a data configuration of file management information stored in the file management information storage unit 23 according to the present exemplary embodiment. The file management information is information to be used for managing files, and is generated corresponding to each file handled by the present system. An item value set in the file management information is displayed on the workspace or referred to in a case where the files are distributed. Information on the processed file may be moved to another storage location, deleted, or the like as appropriate. The file management information includes a file ID, a file name, a person in charge, a status, and process-related information. The file ID is identification information for uniquely specifying the file. The file ID is associated with the file stored in the file storage unit 22. The file name is a name of the file. The person in charge is a user who is in charge of processing the file, and a user ID or a name of a person in charge for identifying the user is set. In the present exemplary embodiment, a case where the name of the person in charge is set is described. The status is information indicating a current status (also referred to as “status”) of the file. The status is updated as appropriate according to a processing status of the file. In FIG. 3, “unassigned”, “requesting”, “request rejected”, “accepted”, “working”, and “completed” are illustrated as item values set in the status, and the present exemplary embodiment is not limited thereto.

The process-related information is information related to a process executed on the file. The process-related information includes attribute information of the file or work information required for processing the file. The process-related information serves as a reference in a case where the administrator distributes the file, and also as a reference for the person in charge to determine whether to accept or reject the file distributed to the person in charge by the administrator.

FIG. 4 is a table illustrating an example of a data configuration of person-in-charge management information stored in the person-in-charge status information storage unit 24 according to the present exemplary embodiment. The person-in-charge management information is information indicating a current status of a user who processes a file, that is, an individual person in charge. The person-in-charge management information includes the person in charge, a distribution rejection flag, and productivity. The person in charge is information for identifying the person in charge, and in the present exemplary embodiment, a name of the person in charge is used. The distribution rejection flag is flag information indicating that an administrator rejects to distribute the file. The distribution rejection flag is set (for example, “1” is set) or cleared (for example, “0” is set) according to a setting operation by the person in charge. The productivity is an index value indicating a production capacity of the person in charge. In the present exemplary embodiment, the productivity is expressed by an average value of a processing time required for each case, that is, an average value of a lead time it takes to process one invoice, and the method of calculating the productivity is not limited thereto. For example, an index value considering a volume such as a file size or the number of pages may be used.

Each of the components 11 to 18 in the file server 10 is realized by a cooperative operation of a computer forming the file server 10 and a program running on a CPU mounted on the computer. Further, each of the storage units 21 to 24 is realized by an HDD mounted on the file server 10. Alternatively, a RAM or an external storage section may be used via the network.

In the present exemplary embodiment, each of the storage units 21 to 24 is provided to manage information, and a configuration of this storage section is an example, and the management method for the information is not limited thereto.

The administrator terminal 30 is an information processing apparatus used by the administrator, and is configured with, for example, a personal computer (PC). The administrator terminal 30 can be realized by a hardware configuration of the general-purpose PC. That is, the administrator terminal 30 is a user interface including a storage section such as a CPU, a ROM, a RAM, and a hard disk drive (HDD), a network interface provided as a communication section, an input section such as a mouse or a keyboard, and a display section such as a display.

The administrator terminal 30 includes a workspace process control unit 31 and a file distribution processing unit 32. The workspace process control unit 31 controls an execution of a process related to a workspace, such as displaying the workspace and accepting input operations by the administrator from the workspace. According to an operation by the administrator, the file distribution processing unit 32 distributes a file that is not yet distributed to any person in charge to assign a job for the file to the person in charge.

Each of the components 31 to 32 in the administrator terminal 30 is realized by a cooperative operation of a computer forming the administrator terminal 30 and a program running on a CPU mounted on the computer.

The person-in-charge terminal 40 is an information processing apparatus used by the person in charge, and is configured with, for example, a PC. The person-in-charge terminal 40 can be realized by a hardware configuration of the general-purpose PC. That is, the person-in-charge terminal 40 is a user interface including a storage section such as a CPU, a ROM, a RAM, and a hard disk drive (HDD), a network interface provided as a communication section, an input section such as a mouse or a keyboard, and a display section such as a display.

The person-in-charge terminal 40 includes a workspace process control unit 41 and a process execution unit 42. The workspace process control unit 41 controls an execution of a process related to a workspace, such as displaying the workspace and accepting input operations by the person in charge from the workspace. The process execution unit 42 executes a process for the file assigned to the person in charge in response to the operation by the person in charge.

Each of the components 41 to 42 in the person-in-charge terminal 40 is realized by a cooperative operation of a computer forming the person-in-charge terminal 40 and a program running by the CPU mounted on the computer.

Further, the program used in the present exemplary embodiment can be provided not only by a communication section but also by storing the program in a computer-readable recording medium such as a CD-ROM or a USB memory. The program provided by the communication section or the recording medium is installed in the computer, and various processes are realized by sequentially executing the program by the CPU of the computer.

In the present exemplary embodiment, in a case where the file server 10 accepts a file to be processed, the administrator displays the file accepted by the file server 10 and not yet distributed to the person in charge on a distribution screen, and performs a predetermined operation on the distribution screen to distribute the file to any person in charge. Meanwhile, since it is required to distribute the file in consideration of load equalization or the like, the administrator wants to distribute the file to the person in charge after confirming in advance a job-load of each person in charge to whom the file is distributed, for example, the number of files possessed by each person in charge. Therefore, a screen for confirming the job-load is displayed to confirm the job-load for each person in charge, and then a screen for distribution to the person in charge is displayed separately. Meanwhile, in this case, a series of operations including the screen switching operation becomes troublesome.

Therefore, in the present exemplary embodiment, in order to reduce the number of operations of the administrator required to distribute the file to the person in charge, the file that is not distributed and the file that is distributed to each person in charge are displayed on an identical screen, that is, in the workspace. Then, regarding the file distributed to each person in charge, for example, a progress status of the process for each file of each person in charge is displayed as a status of each person in charge. Thus, the administrator refers to the workspace to distribute the unassigned file to any person in charge while considering the load of the job of each person in charge.

In the present exemplary embodiment, the file is distributed to any person in charge, so that the job for the file is assigned to the person in charge. Meanwhile, since “distribute”, “allocate”, or “assign” has the same meaning in a case of associating a file or a job with a person in charge, these terms are approximately synonymous in the present exemplary embodiment. Further, a user who uses the person-in-charge terminal 40 is a candidate of a person in charge and becomes the person in charge of the file only after the file is allocated and the file is accepted. Here, for convenience of explanation, a user other than the administrator will be referred to as a “person in charge” regardless of whether or not the file is distributed to the user, in order to make it easier to distinguish from the administrator who performs the file distribution process.

Next, an operation in the present exemplary embodiment will be described.

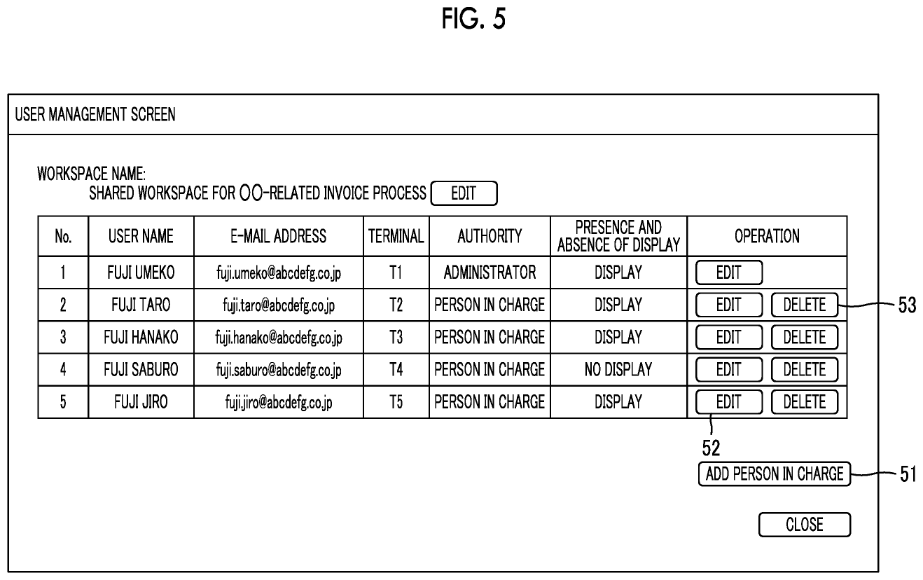

First, in a case where a use of the present system is started, it is necessary to set user management information. FIG. 5 illustrates a display example of a user management screen used for setting the user management information in the present exemplary embodiment. An administrator sets and registers a user of the present system from the user management screen. The administrator first sets a workspace to be set by the user, and then sets the user for the set workspace. In a case where a new user for the set workspace is registered on the user management screen, by selecting a person-in-charge addition button 51, a new serial number is allocated to the user, and an item value is set for each of a user name, an e-mail address, a terminal, authority, and presence and absence of display in a setting line of the user. In a case where the setting is completed, an edit button 52 and a delete button 53 are displayed in an operation item field. Since at least one administrator is required for the present system, in a case where there is only one user for whom “administrator” is set in an authority item field, only the edit button 52 is associated with the user. Then, in a case where it is required to change the item value for the registered user, by selecting the edit button 52, an editable state is set, so that the administrator changes the set item value. In a case where it is required to delete the information on the registered user, the delete button 53 corresponding to the user is selected.

In a case where “no display” is set in the item field of the presence and absence of display, the person in charge is not a display target in the corresponding workspace (in the example illustrated in FIG. 5, “oo-related invoice process workspace”). Therefore, the person in charge is not an assignment target for the file.

In the above description, the administrator is a central body, and the user management unit 11 generates user management information according to the operation by the administrator, and registers the management information in the user management information storage unit 21, or edits or deletes the user management information registered in the user management information storage unit 21.

By setting the user management information on the user who uses the present system as described above, the present system can be used.

In a case where a file to be processed is transmitted to the file server 10, the file reception unit 12 saves the file in the file storage unit 22. In a case where the file is newly saved in the file storage unit 22, the file management unit 13 generates file management information related to the saved file and registers the file management information in the file management information storage unit 23. A file ID, a file name, and work information included in the generated file management information can be obtained from the transmitted file, attribute information or additional information of the file, or the like. Further, since the person in charge is not determined at a time of newly registering the file, the file management unit 13 sets a blank as an initial value in the item of the person in charge. In addition, “unassigned” is set as an initial value in the status item. The file server 10 repeatedly executes the above processes each time a file is transmitted.

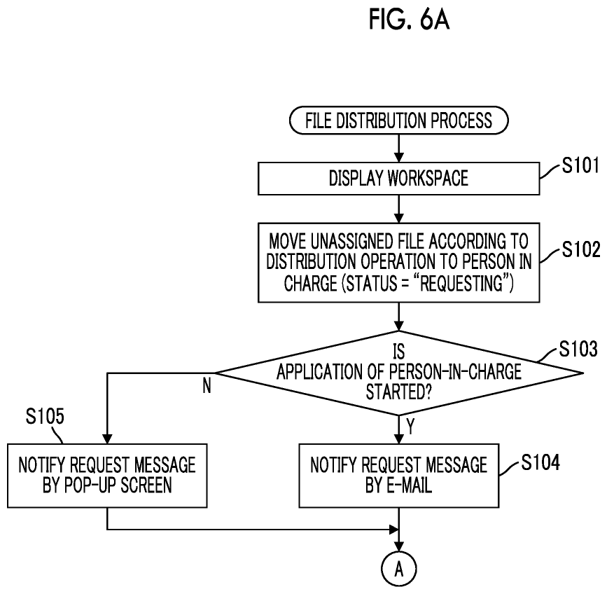

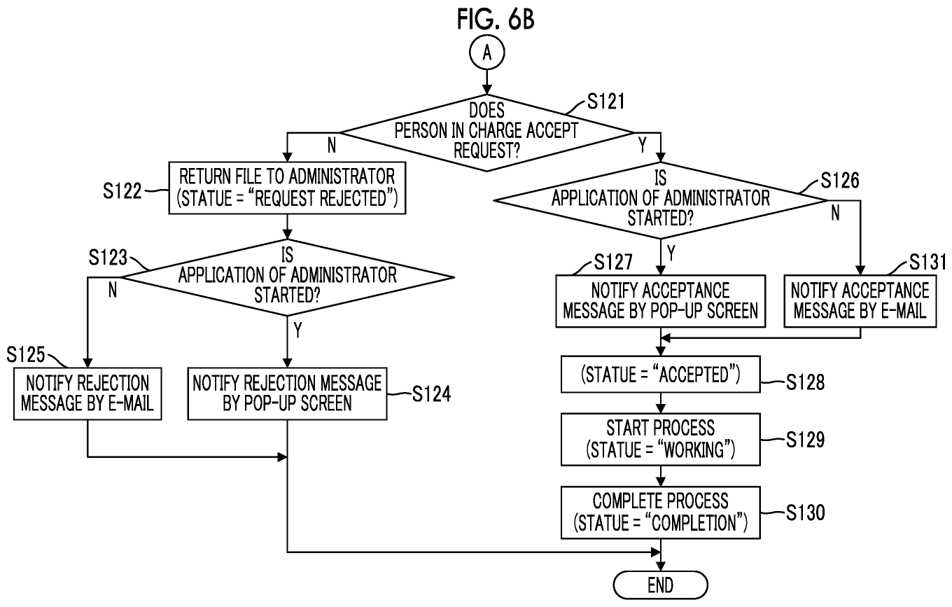

Hereinafter, in the present exemplary embodiment, processes performed until a file is processed will be described with reference to the flowcharts illustrated in FIGS. 6A and 6B.

An administrator displays a workspace on a screen by starting a predetermined application with the administrator terminal 30, in order to distribute the file (step S101). The workspace may be displayed by the started application starting a browser and acquiring a web page from the file server 10, for example. The workspace generation unit 14 in the file server 10 refers to file management information stored in the file management information storage unit 23 and person-in-charge management information stored in the person-in-charge status information storage unit 24 in response to a request from the application on the administrator terminal 30 to generate a workspace for administrator. The display control unit 151 causes the administrator terminal 30 to display the workspace by transmitting the generated workspace to the administrator terminal 30.

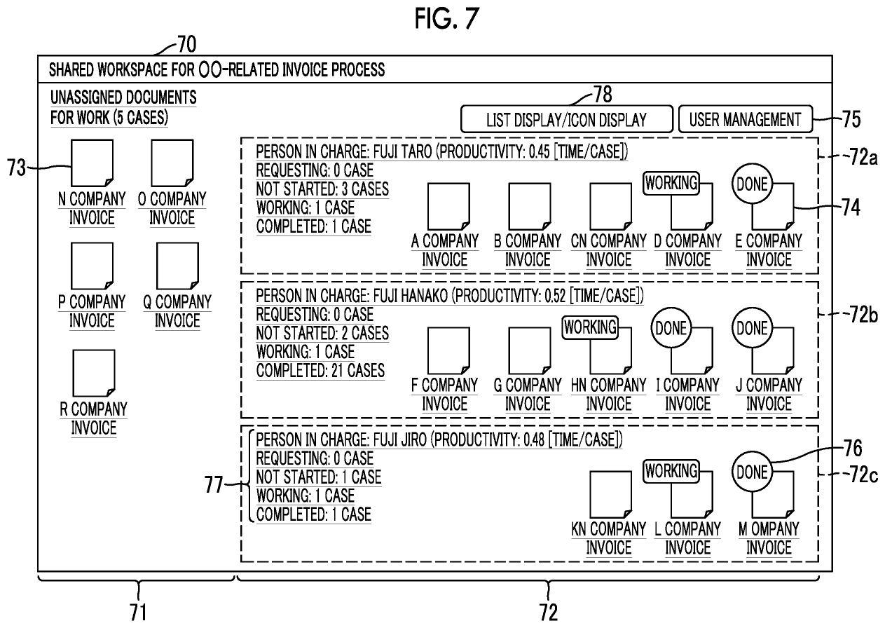

FIG. 7 is a diagram illustrating an example of a screen display of a workspace 70 for administrator displayed on the administrator terminal 30 according to the present exemplary embodiment. The workspace 70 illustrated in FIG. 7 is a work space used for performing a work of distributing an invoice as a file to any person in charge, and is a screen corresponding to the above-described distribution screen. The workspace 70 for administrator has an unassignment display region 71 and a person-in-charge-specific display region 72. The unassignment display region 71 is a first display region in which files 73 that are not yet distributed to the person in charge among files received by the file reception unit 12 are displayed. The person-in-charge-specific display region 72 is a second display region in which files 74 distributed to the respective persons in charge are displayed. As illustrated in FIG. 7, in the person-in-charge-specific display region 72, the files distributed to the respective persons in charge are displayed separately in person-in-charge-specific file display regions 72a, 72b, and 72c for each person in charge (hereinafter, “individual display region”). The individual display regions 72a, 72b, and 72c are collectively referred to as “person-in-charge-specific display region 72” or “individual display region 72” in a case where it is not necessary to distinguish the individual display regions 72a, 72b, and 72c from each other.

In this manner as the present exemplary embodiment, the display region of the files that are not distributed yet and the display region of the files that are distributed to each person in charge are displayed on one screen, that is, in a case of the present exemplary embodiment, on the same workspace 70. Further, the administrator can switch the displays on the user management screen illustrated in FIG. 5 by selecting a user management button 75. A list display and icon display button 78 is a display format switching button for displaying a file in an icon format or a list format.

Specifically, the files 73 and 74 are not the actual files but an image called an icon or the like represented by a reduced image or the like of the file, and in the present exemplary embodiment, the files 73 and 74 are simply referred to as a “file” for convenience of explanation.

In the person-in-charge-specific display region 72 illustrated in FIG. 7, each of the individual display regions 72a, 72b, and 72c of “Fuji Taro”, “Fuji Hanako”, and “Fuji Jiro” is displayed as persons in charge of processing the files. This follows the setting of the item “presence and absence of display” included in the user management information illustrated in FIG. 2. As is clear from the user management information illustrated in FIG. 2, the workspace 70 illustrated in FIG. 7 can be seen to be displayed on the administrator terminal 30 by the administrator “Fuji Umeko”.

A mark 76 indicating a status of a job by each person in charge, in other words, a status of the file, is added to the file 74 displayed in the person-in-charge-specific display region 72. The mark 76 added to and displayed on each file 74 is determined according to setting contents to the “status” of the file management information illustrated in FIG. 3. Therefore, a type of the mark 76 is the number of item values set in the “status” of the file management information. The “done” mark 76 illustrated in FIG. 7 corresponds to a status “completed”. In the present exemplary embodiment, by using the mark 76, a progress status of each file by each person in charge is displayed and seen. Meanwhile, by not adding the mark 76 to the “not started” file 74, the file 74 is displayed so that the status is understood that the person in charge does not start yet. Further, in the present exemplary embodiment, the mark 76 is added only to the file displayed in the person-in-charge-specific display region 72, and the mark may be also added to the file displayed in the unassignment display region 71. The form of the mark 76 illustrated in FIG. 7 is an example, and does not have to be limited to a shape, an additional position, or the like illustrated in FIG. 7.

In the person-in-charge-specific display region 72, status information 77 indicating a processing status of the file of each person in charge is further displayed for the administrator. In the “requesting”, “not started”, “working”, and “completed” included in the status information 77, an aggregated value for each status of each file 74 is illustrated. Further, in the top line of the status information 77, productivity is displayed as an index value indicating a production capacity of the person in charge together with a name of the person in charge. In the productivity, person-in-charge status information illustrated in FIG. 4 is displayed.

The status of the person in charge does not have to be limited to the information illustrated in the status information 77. For example, information indicating whether or not the person-in-charge terminal 40 used by each person in charge is currently online may be included. As described above, the status of each person in charge includes the progress status of each file, the production capacity, the online and offline state of the person-in-charge terminal 40, and the like.

The workspace 70 for administrator displayed on the administrator terminal 30 is described above, and the workspace 70 is generated by the workspace generation unit 14 in response to the operation reception unit 152 receiving an operation by the administrator from the administrator terminal 30. That is, the workspace generation unit 14 specifies a user to be displayed by referring to user management information and extracts information on the specified user from file management information and person-in-charge status information to generate the workspace 70. Then, the display control unit 151 transmits the workspace 70 to the administrator terminal 30 to display a screen on the administrator terminal 30 in cooperation with the workspace process control unit 31.

Subsequently, the administrator selects the file 73 to be distributed to the person in charge from the files 73 that are displayed in the unassignment display region 71 and that are not yet distributed to the person in charge, and distributes the selected file to the person in charge according to an operation of moving the file to the person-in-charge-specific display region 72.

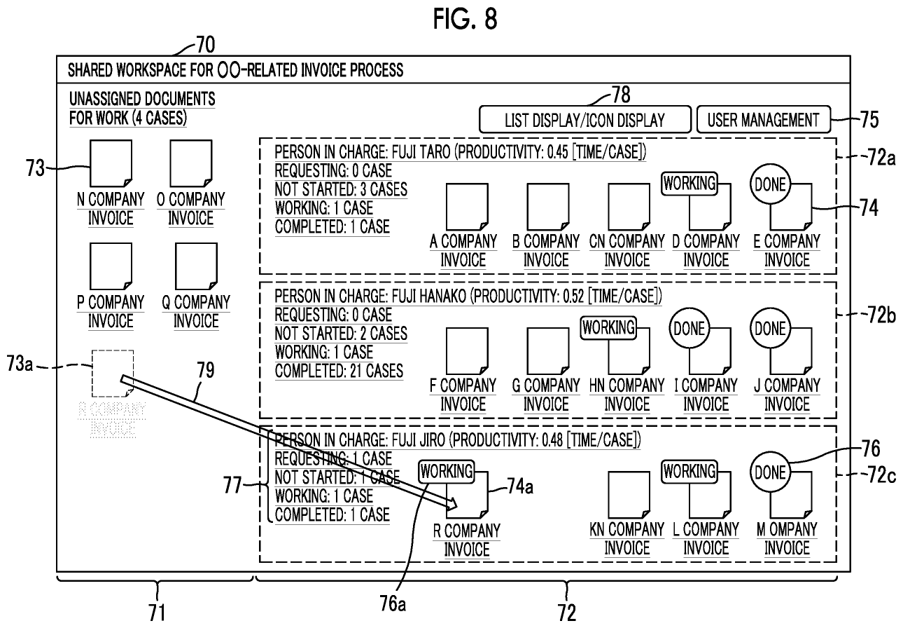

FIG. 8 is a screen display example of the same workspace 70 as in FIG. 7, and is a diagram illustrating a movement operation of the file 73 by an administrator and information updated in response to the movement operation. For example, the administrator moves a file 73a to be distributed to the individual display region 72c, wanted as a person in charge (“Fuji Jiro” in FIG. 8) by a drag and drop operation as indicated by an arrow 79 (step S102). In response to this operation, the file 73a is erased from the unassignment display region 71 as illustrated by a broken line in FIG. 8, and a file 74a is displayed in the individual display region 72c.

The above process is executed as follows. That is, in a case where the administrator performs a file distribution operation, that is, the above-described drag and drop operation, the file distribution processing unit 32 notifies the file server 10 of the operation content. In a case where the operation reception unit 152 in the file server 10 receives the file distribution operation (the above-described “drag and drop operation”) performed by the administrator on the workspace 70, the display control unit 151 displays the file 74a in the individual display region 72c. At the same time, the file management unit 13 sets a name of the person in charge to be a request destination to the “person in charge” in file management information of the distributed file 74a, and changes the “status” from “unassigned” to “requesting”. Further, the display control unit 151 adds a “requesting” mark 76a to the file 74a and displays the file 74a according to the change of the “status”, and updates the number of requesting cases in the status information 77 to one.

According to the present exemplary embodiment, the administrator can check the status of each person in charge, that is, the number of files in charge of each person in charge and the number of cases for each file status on a display screen of the workspace 70 used for distributing the files 73, so that the appropriate person in charge for processing the file 73 that is not yet distributed can be found and the file is distributed. Further, since the unassignment display region 71 of the file 73 as a distribution source and the individual display region 72 of each person in charge to be a distribution destination are displayed on the identical screen, the administrator can distribute the file by the simple operation such as the drag and drop operation.

Meanwhile, the distribution of the above files is based on the intention of the administrator, and may not reflect the intention of the person in charge who is a destination of the file distribution. In other words, the file is moved by an offer of the administrator. Therefore, in the present exemplary embodiment, the person in charge can select whether or not to accept the offer from the administrator.

Therefore, in a case where it is detected that the “status” in the file management information is changed from “unassigned” to “requesting” as the file is moved from the unassignment display region 71 to the individual display region 72, the terminal monitoring unit 153 checks whether or not an application for displaying the workspace is started on the person-in-charge terminal 40 used by the person in charge who is the request destination. This checking may be performed by inquiring to the workspace process control unit 41 or the like. The person-in-charge terminal 40 used by the person in charge who is the request destination can be specified by referring to the user management information.

In a case where a predetermined application is started on the person-in-charge terminal 40 of the person in charge as the request destination, that is, in a case where the workspace is displayed on the screen (Y in step S103), the notification unit 17 notifies the person in charge that a job is requested by displaying a request message of the job according to the allocation of the file on the workspace on a pop-up screen (step S104). In addition, the administrator distributing the file to the person in charge has the same meaning as requesting the person in charge to do the job. On the other hand, in a case where the predetermined application is not started, that is, in a case where the workspace is not displayed on the screen (N in step S103), the notification unit 17 notifies the request message by e-mail (step S105). An e-mail address as a destination can be specified by referring to the user management information.

In the present exemplary embodiment, the request message is notified in real time according to the operation that the administrator moves the file (the above-described “drag and drop operation”).

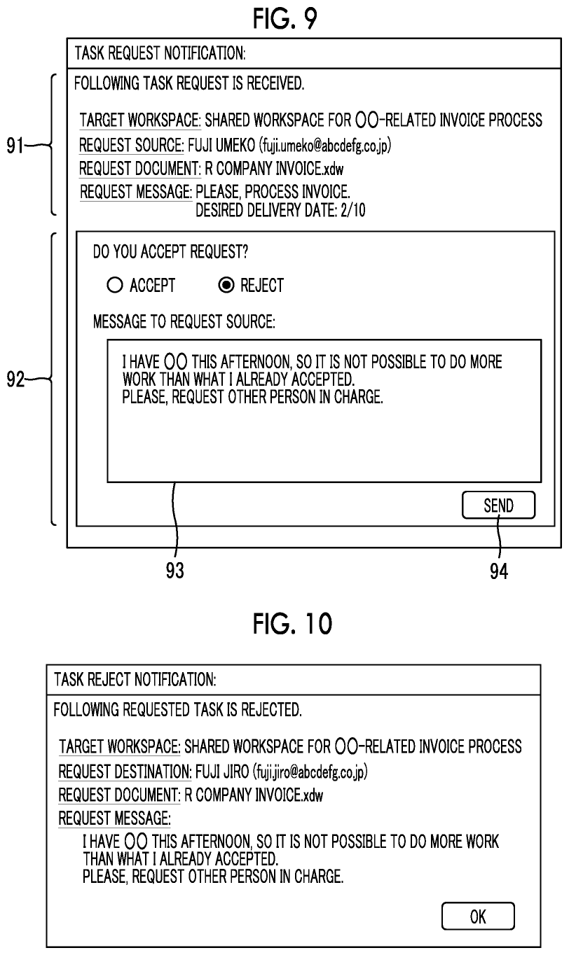

FIG. 9 is a diagram illustrating an example of contents of a request message according to the present exemplary embodiment. A format of the request message may be changed between a pop-up screen and an e-mail.

The request message includes a notification region 91 and a response region 92. The content of the request is described in the notification region 91. The response region 92 is a region for setting a response to the request. The person in charge determines whether or not to accept the request by referring to the contents of the notification region 91 or the like.

In a case where the person in charge does not accept the request (N in step S121), the person in charge selects “reject” in the response region 92. In a case where there is a message to be conveyed to the administrator, a message field 93 is filled and then a send button 94 is selected. The operation reception unit 152 in the file server 10 receives a message that the person in charge rejects the request according to the selection of the send button 94 by the person in charge. In a case where the request is rejected, the file server 10 performs a process of canceling the process executed by the administrator by the drag and drop operation. That is, in a case where the operation reception unit 152 in the file server 10 receives the message that the person in charge rejects according to the selection of the send button 94, the file management unit 13 deletes the name of the person in charge from the “person in charge” in the file management information of the distributed file 74a and changes the “status” from “requesting” to “request rejected” to return the file to the administrator (step S122). In a case where a predetermined application is started on the administrator terminal 30, that is, in a case where the workspace 70 is displayed on the screen (Y in step S123), the notification unit 17 notifies the administrator that the file is returned from the person in charge by displaying a rejection message on the unassignment display region 71 of the workspace 70 on a pop-up screen, and the requested job is rejected (step S124). Further, the display control unit 151 erases the file 74a displayed in the individual display region 72c and restores the display of the file 73a in the unassignment display region 71 in a case where the file is returned to the administrator. Further, the display control unit 151 updates the number of requesting cases in the status information 77 to 0 in response to the change in the “status”.

In a case where the predetermined application is not started, that is, in a case where the workspace is not displayed on the screen (N in step S123), the notification unit 17 notifies the rejection message by e-mail (step S125). An e-mail address as a destination can be specified by referring to the user management information.

FIG. 10 is a diagram illustrating an example of contents of a rejection message used in the present exemplary embodiment. A format of the rejection message may be changed between a pop-up screen and an e-mail. As illustrated in FIG. 10, the rejection message includes a message that the person in charge rejects the request and a message written by the person in charge.

On the other hand, in a case where the person in charge accepts the request (Y in step S121), the person in charge selects “accept” in the response region 92. In a case where there is a message to be conveyed to the administrator, a message field 93 is filled and then a send button 94 is selected. The operation reception unit 152 in the file server 10 receives a message that the person in charge accepts according to the selection of the send button 94 by the person in charge. Here, in a case where a predetermined application is started on the administrator terminal 30, that is, in a case where the workspace 70 is displayed on the screen (Y in step S126), the notification unit 17 notifies the administrator that the requested job is accepted by the person in charge by displaying an acceptance message on a pop-up screen in the unassignment display region 71 of the workspace 70 (step S127). Further, the file management unit 13 changes the “status” in the file management information of the distributed file 74b from “requesting” to “accepted”.

On the other hand, in a case where the predetermined application is not started, that is, in a case where the workspace is not displayed on the screen (N in step S126), the notification unit 17 notifies the acceptance message by e-mail (step S131). An e-mail address as a destination can be specified by referring to the user management information.

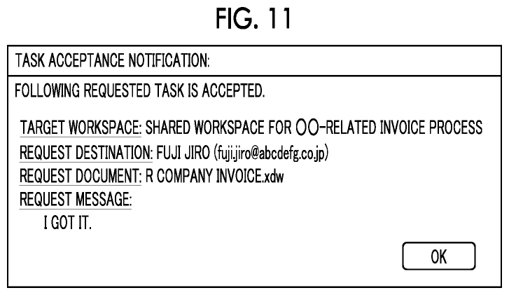

FIG. 11 is a diagram illustrating an example of contents of an acceptance message used in the present exemplary embodiment. A format of the acceptance message may be changed between a pop-up screen and an e-mail. As illustrated in FIG. 11, the acceptance message includes a message that the person in charge accepts the request and a message written by the person in charge.

After that, the process execution unit 42 starts executing a predetermined process on the file 74b in response to an instruction from any person in charge. The process monitoring unit 154 monitors the execution of processing in the person-in-charge terminal 40, and in a case where the start of the process on the file 74b is detected, the file management unit 13 changes the “status” in the file management information of the file 74b corresponding to the started process from “accepted” to “working” (step S129).

The process execution unit 42 completes the process on the file 74b, and in a case where the process monitoring unit 154 detects the completion of the process on the file 74b, the file management unit 13 changes the “status” in the file management information of the file 74b corresponding to the completed process from “working” to “completed” (step S130).

In steps 128 to 130, as the “status” in the file management information is updated, the status information 77 displayed in the workspace 70 and the mark 76 added to the file 74 to be processed are also updated as appropriate.

In a case where the process monitoring unit 154 detects the completion of the process by the person in charge, the person-in-charge status management unit 16 acquires a processing time required for the process, recalculates the productivity of the person in charge, and updates the item value of the productivity of the person in charge included in the person-in-charge status information. Along with this, the display control unit 151 updates the displayed productivity value of the person in charge.

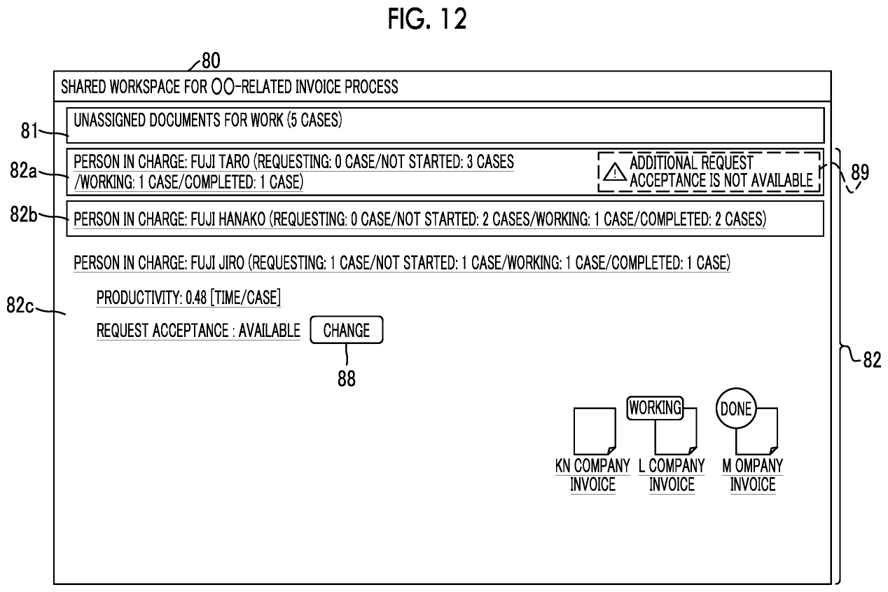

Meanwhile, in a case where the person in charge rejects the allocated file or executes the process, the workspace is displayed on the screen of the person-in-charge terminal 40 and the file to be processed is selected. Here, the workspace displayed on the person-in-charge terminal 40 will be described with reference to FIG. 12.

FIG. 12 is a diagram illustrating an example of a screen display of a workspace for person in charge in the present exemplary embodiment. A workspace 80 for person in charge also basically displays the same information as the workspace 70 for administrator illustrated in FIG. 7. Meanwhile, since the person in charge does not need to know information other than the person in charge in detail, the display form of the information differs. FIG. 12 illustrates a display example of the workspace 80 in a case where the person in charge is “Fuji Jiro”.

In the workspace 80, an unassignment display region 81 and a person-in-charge-specific display region 82 are displayed, in the same manner as the workspace 70 for administrator. Meanwhile, since the person in charge does not need to know the information on the unassigned file, the information displayed in the unassignment display region is largely omitted as compared to the unassignment display region 81 displayed in the administrator workspace 70, and has only the number of work unassigned documents, that is, the number of files for which the person in charge is not yet determined because the files are not distributed. In addition, since the information on the persons in charge other than the person in charge displayed in the person-in-charge-specific display region 82 is not particularly required, for the persons in charge other than the person in charge, of information included in the status information, only the number of cases for each progress status of the file of the person in charge is remained.

Meanwhile, regarding the distribution of files from the administrator, the person in charge can select whether or not to accept the job request for the file, that is, an offer, as described above. That is, the individual correspondence is described. Meanwhile, in a case where the person in charge cannot accept the requested job for a while since the person in charge has a large number of files, for example, it is troublesome to reject a job request each time the file is distributed.

Therefore, in the present exemplary embodiment, a change button 88 is provided in the workspace 80 for person in charge. By selecting the change button 88, the person in charge can switch whether to accept the file, that is, “available” or “unavailable”.

In a case where the operation reception unit 152 in the file server 10 accepts an operation of the change button 88 by the person in charge, the person-in-charge status management unit 16 sets or clears the person-in-charge status information illustrated in FIG. 4 by changing the distribution rejection flag corresponding to the person in charge who operates the change button 88. In a case where the distribution rejection flag is set according to the operation of the person in charge, that fact is displayed in the corresponding individual display region 72. FIG. 12 illustrates an example in which rejection information 89 indicating that the person in charge “Fuji Hanako” rejects distribution of the file is displayed in the individual display region 72b of the person in charge. Thus, in a case where a job is requested, in addition to the progress status of the process on the files of other persons in charge, it is possible to determine whether or not to accept the request by referring to the status of whether or not the distribution of the files is rejected.

The workspace 80 for person in charge displayed on the person-in-charge terminal 40 is described above, and the workspace 80 is generated by the workspace generation unit 14 in response to an operation from the person in charge. That is, the workspace generation unit 14 specifies a user to be displayed by referring to user management information and extracts information on the specified user from file management information and person-in-charge status information to generate the workspace 80. In particular, in a case where the person in charge makes the display request, the workspace generation unit 14 generates the workspace 80 for person in charge and the person in charge is specified at that time. In FIG. 12, the workspace 80 is generated so that information on the person in charge is displayed in detailed contents as illustrated in an individual display region 82c, and information on other users is displayed in simplified contents as illustrated in individual display regions 82a and 82b, respectively. Then, the display control unit 151 transmits the workspace 80 to the person-in-charge terminal 40 of the person in charge who requests the display, so that the person-in-charge terminal 40 displays the screen in cooperation with the workspace process control unit 31.

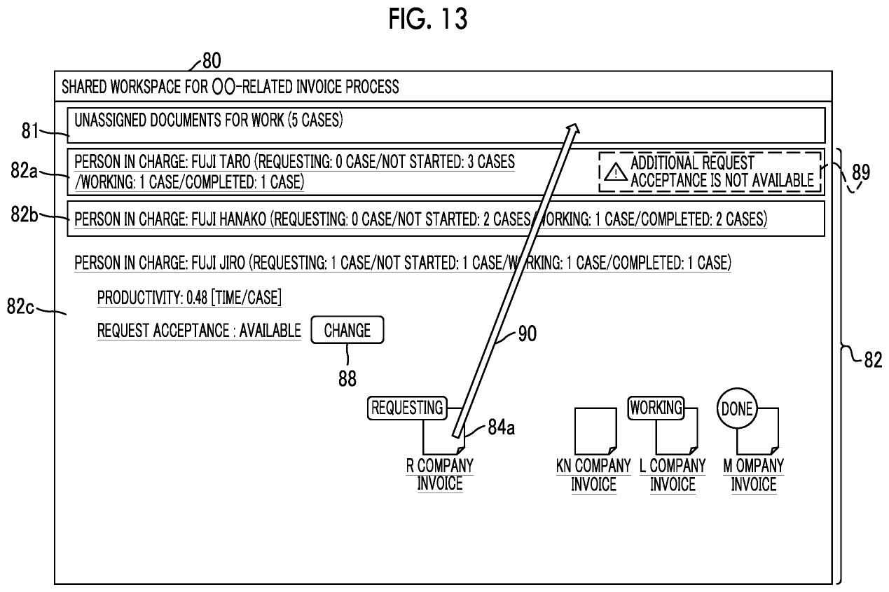

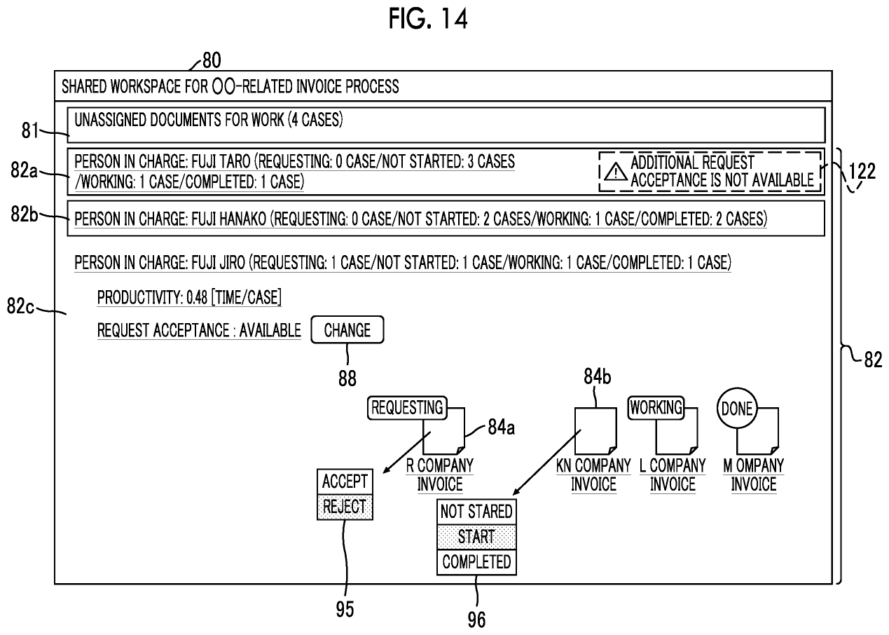

Meanwhile, in a case where the person in charge is displaying the workspace 80 on the person-in-charge terminal 40 and the files are distributed by the administrator, as illustrated in FIG. 13, a distributed file 84a is displayed in the individual display region 72c of the person in charge. Then, as described above, the person in charge accepts the file 84a and responds whether or not to accept the requested job. In a case of rejection, the person in charge restores the file as described above, and specific examples of the operation are illustrated in FIGS. 13 and 14.

In FIG. 13, the file 84a is moved to the unassignment display region 81 by an operation of moving the file 84a as illustrated by an arrow 90, for example, a drag and drop operation. In response to this operation, the number of unassigned documents in the unassignment display region 81 returns to 5, and the file 84a is deleted from the individual display region 72c.

In FIG. 14, in a case where a predetermined operation is performed on a file to be processed, for example, right-clicking is performed on the file 84a, a pull-down menu 95 is displayed. The file can be returned to the administrator by selecting “reject” from this pull-down menu 95.

In a case where “accept” is selected from the pull-down menu 95, the file is accepted, so the “status” in the file management information of the file 84a is changed from “unassigned” to “requesting”. The update of information and the like are already described in a case where the workspace 70 for administrator is described, so the description thereof will be omitted here.

Further, FIG. 14 further illustrates an example when the accepted file 84b is right-clicked. In a case where the file 84b is right-clicked, a pull-down menu 96 is displayed. The person in charge can start processing the file by selecting “start” from the pull-down menu 96. The file management information of the file is updated according to the start of the process, and the update of the information and the like are already described, so the description thereof will be omitted here.

As described above, the administrator uses the information displayed in the workspace 70 in a case of determining which person in charge to distribute the file to. On the other hand, the person in charge uses the information displayed in the workspace 80 in a case of determining whether to accept the file distributed by the administrator. The time for the person in charge to process the file may differ depending on a size of the file, contents of the process, and the like. In addition, a deadline for completing the process may be set for business purposes. Therefore, in the present exemplary embodiment, apart from the information already described such as the status information 77, it is possible to further provide information that can be an index of the determination by the administrator and the person in charge.

For example, in a case where the operation reception unit 152 detects that a predetermined operation, for example, a right-click operation is performed by the user on the file displayed in the workspaces 70 and 80, the file management unit 13 reads the process-related information corresponding to the operated file from the file management information. The display control unit 151 displays the read process-related information on the workspaces 70 and 80 in association with the operated file.

In a case where the user is an administrator, the administrator can select a person in charge who is appropriate for processing the file by referring to the process-related information corresponding to this file. In a case where the administrator does not know the ability of the person in charge, for example, in a case where a predetermined operation, for example, a right-click operation, is performed on a name of the person in charge displayed in the person-in-charge-specific display region 72, the user management unit 11 reads and displays personal information (not illustrated) of the person in charge included in the user management information, specifically, information such as a specialized field, a specialty field, and a carrier from the user management information storage unit 21 (not illustrated). The administrator may be able to select a distribution destination of the file by referring to the process-related information of the displayed file and the personal information of the person in charge.

Further, in a case where the user is a person in charge, the person in charge can determine whether to accept or reject the file by referring to the process-related information corresponding to the distributed file.

In the present exemplary embodiment, the process-related information is displayed by a right-clicking operation, and the present exemplary embodiment is not limited to this. For example, a display button may be added to the files 73 and 74 and displayed, and the files 73 and 74 may be displayed according to a selection operation of the display button. Alternatively, the files 73 and 74 may be displayed at all times.

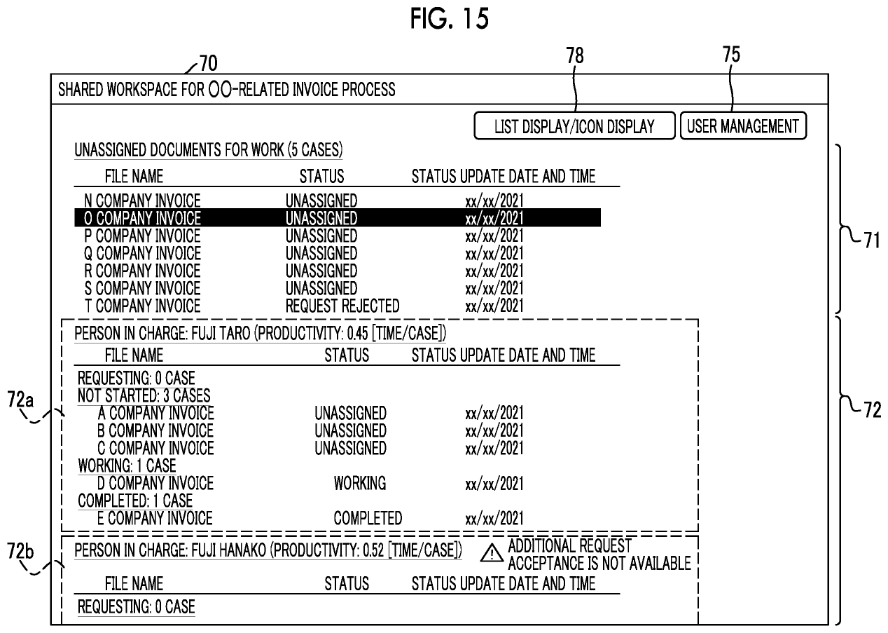

FIG. 15 is a diagram illustrating another example of the screen display of the workspace 70 for administrator displayed on the administrator terminal 30 in the present exemplary embodiment. FIG. 7 illustrates a display example in a case where the file is displayed in the icon format, and FIG. 15 illustrates a display example in a case where the file is displayed in the list format. The workspace 70 illustrated in FIG. 7 and the workspace 70 illustrated in FIG. 5 are switched and displayed by the administrator selecting the list display and icon display button 78.

In the workspace 70 in the list format, in order for the administrator to distribute the files, the individual display region 72 of the person in charge of a distribution destination is displayed on the screen by scrolling or the like as necessary, and in the same manner as FIG. 7, the file to be distributed may be moved to the individual display region 72 of the person in charge whom the administrator wants to give charge by a drag and drop operation.

As described above, according to the present exemplary embodiment, the file to be distributed and the person in charge to be distributed are displayed on the identical screen in the workspace 70, so that the administrator can distribute the file to the person in charge with a few simple operations (“drag and drop operation” in the above example).

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
perform control such that a first display region in which a file that is not distributed to a person in charge is displayed and a second display region in which a file that is distributed to each person in charge is displayed are displayed on an identical screen;
perform control such that a status of each person in charge is displayed in the second display region; and
distribute the file displayed in the first display region to the person in charge according to an operation of moving the file displayed in the first display region to the second display region.

2. The information processing apparatus according to claim 1, wherein the processor is configured to:
notify the person in charge that the file is distributed according to the operation.

3. The information processing apparatus according to claim 1,
wherein the status is a processing status of the file of each person in charge.

4. The information processing apparatus according to claim 1, wherein the processor is configured to:
return the file displayed in the second display region to a state of the file that is not distributed to any person in charge, according to an operation of moving the file displayed in the second display region to the first display region by the person in charge.

5. The information processing apparatus according to claim 4, wherein the processor is configured to:
notify an administrator that the file is returned from the person in charge, according to the operation by the person in charge.

6. The information processing apparatus according to claim 1, wherein the processor is configured to:
in a case where the person in charge sets rejection of distribution of the file, perform control to display that the distribution of the file is rejected, in a person-in-charge-specific file display region of the person in charge in the second display region.

7. The information processing apparatus according to claim 1, wherein the processor is configured to:
perform control to display an index value indicating a production capacity of the person in charge, in a person-in-charge-specific file display region of each person in charge in the second display region.

8. The information processing apparatus according to claim 1, wherein the processor is configured to:
perform control to display work information required for processing the file.

9. The information processing apparatus according to claim 7, wherein the processor is configured to:
perform control to display work information required for processing the file.

10. A non-transitory computer readable medium storing a program causing a computer to realize:
a function of performing control such that a first display region in which a file that is not distributed to a person in charge is displayed and a second display region in which a file that is distributed to each person in charge is displayed are displayed on an identical screen;
a function of performing control such that a status of each person in charge is displayed in the second display region; and
a function of distributing the file displayed in the first display region to the person in charge according to an operation of moving the file displayed in the first display region to the second display region.

11. An information processing method comprising:
performing control such that a first display region in which a file that is not distributed to a person in charge is displayed and a second display region in which a file that is distributed to each person in charge is displayed are displayed on an identical screen;
performing control such that a status of each person in charge is displayed in the second display region; and
distributing the file displayed in the first display region to the person in charge according to an operation of moving the file displayed in the first display region to the second display region.
